(19) United States
(12) Patent Application Publication
(10) Pub. No.: US 2010/0325677 A1
(43) Pub. Date: Dec. 23, 2010

(54) TV Network-Based Ethernet Data Transmission Method and Physical Layer Transmission Apparatus

(75) Inventors: Yang Yu, Beijing (CN); Weizhou Li, Beijing (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: HANGZHOU H3C TECHNOLOGIES CO., LTD., Zhejiang Province, Hangzhou City (CN)

(21) Appl. No.: 12/521,565

(22) PCT Filed: Jul. 11, 2007
(86) PCT No.: PCT/CN07/02123

§ 371 Date: Jun. 26, 2009

(30) Foreign Application Priority Data
Jan. 10, 2007 (CN) 200710063380.3

(51) Int. Cl. H04N 7/173

(52) U.S. Cl. 725/109

(57) ABSTRACT

Embodiments of the present invention provide a television, TV, network based Ethernet data transmission method and a physical layer, PHY, transmission apparatus. The method includes: determining in advance data transmission speed according to bidirectional frequency spectrum width reserved in a TV network; setting working speed of transmitting and receiving of a PHY transmission apparatus according to the determined data transmission speed to make the working speed match the data transmission speed; receiving and transmitting, by the PHY transmission apparatus, data with the transmission speed; performing, by the PHY transmission apparatus, speed matching for the data according to speed of a Media Access Control, MAC, layer interface; receiving and transmitting, by the MAC layer interface, the data after completing the speed matching. The PHY transmission apparatus includes: a transmitting unit, a receiving unit and a variable speed control unit.

### FIELD OF THE INVENTION

The present invention relates to an Ethernet data transmission method, and more particularly, to a method for performing Ethernet transmission which is based on a TV network and takes a coaxial-cable as a medium, and also relates to a physical layer (PHY) transmission apparatus for performing the Ethernet transmission via the TV network.

### BACKGROUND OF THE INVENTION

A user may access existing Television network (TV network for short) based on the coaxial-cable, and the user may receive TV programs via the coaxial-cable. Frequency band of the coaxial-cable for the TV network is in a range from 5 MHz to 1 GHz, in which the frequency band in a range from 65 MHz to 1 GHz is used as channels of the TV programs, while the frequency band in a range from 5 MHz to 65 MHz is taken as reserved frequency band, so as to make reconstruction of bidirectional data transmission to the existing TV network. While, the bidirectional data of the Ethernet data over the TV network is an actively researched and developed direction in the industry, at present.

However, there are mainly two types of existing Ethernet transmission standards. One is 10M Ethernet, i.e., transmission speed of signal is 10 Mbps. The other is 100M Ethernet, i.e., transmission speed of signal is 100 Mbps. The 10M Ethernet adopts Manchester code, which is also referred to as Manchester phase code. In accordance with the Manchester code, each bit is implemented via phase change, i.e., a rising edge in the middle of a clock cycle is used for denoting “1”, while a falling edge in the middle of a clock cycle is used for denoting “0”. Thus, the 10M Ethernet occupies bandwidth of 20 MHz. Since the bandwidth of the 10M Ethernet does not exceed bidirectional frequency spectrum width reserved in the TV network, TV programs will not be affected. In addition, according to the existing standard, the 100M Ethernet adopts a 4B/5B coding mode, which is a block coding mode, i.e., a four-bit block is coded to generate a five-bit block. Since in the five-bit block, the conversion of “1” is performed at least twice, clock synchronization may always be performed in the five-bit block. After the 4B/5B coding, the 100M Ethernet actually needs to occupy the bandwidth of 100*( 5/4)=125 MHz.

Thus, if Ethernet data bidirectional transmission is performed over the TV network, since only 20 MHz reserved bandwidth of the TV network is needed to be occupied when adopting a standard transmission technology of the 10M Ethernet, the reserved frequency band in the TV network is not fully utilized. When adopting a standard transmission technology of the 100M Ethernet, 125 MHz bandwidth is needed to be occupied which exceeds the width of the reserved frequency band of the TV network, channels for transmitting the TV programs will be affected. How to fully utilize the bidirectional frequency spectrum width reserved in the TV network, so as to enhance the transmission speed of uplink Ethernet data over the TV network becomes a stringent problem to be solved currently.

### SUMMARY OF THE INVENTION

Embodiments of the present invention are provided to solve the above-mentioned problem. In embodiments of the present invention, a TV network based Ethernet data transmission method and a PHY transmission apparatus are provided, by which the reserved bidirectional frequency spectrum width in the TV network may be fully utilized and the speed for transmitting Ethernet over the TV network may be enhanced.

In order to achieve the above objective, an embodiment of the present invention provides a TV network based Ethernet data transmission method. The method includes:

determining Ethernet data transmission speed according to bidirectional frequency spectrum width reserved in a TV network;

setting working speed of transmitting and receiving of a Physical Layer, PHY, transmission apparatus according to the determined data transmission speed to make the working speed match the data transmission speed;

receiving and transmitting, by the PHY transmission apparatus, data with the transmission speed;

performing speed matching for the data according to speed of a Media Access Control, MAC, layer interface; and

receiving and transmitting, by the MAC layer interface, the data after completing the speed matching.

In order to achieve the above objective, another embodiment of the present invention provides a PHY transmission apparatus for transmitting Ethernet data over a television, TV, network, adapted to connect to an external collinear apparatus and a Media Access Control, MAC, layer interface unit at two ends of the PHY transmission apparatus, in which the PHY transmission apparatus includes:

a transmitting unit,

a receiving unit and

a variable speed control unit, adapted to set working speed of the transmitting unit and that of the receiving unit according to data transmission speed which is determined based on bidirectional frequency spectrum width reserved in the TV network.

With the embodiments of the present invention, the Ethernet transmission over the TV network may be implemented, meanwhile the bidirectional frequency spectrum width reserved in the TV network may be fully utilized, and the transmission speed of the Ethernet may be enhanced as much as possible.

The technical scheme of the present invention is further described in detail hereinafter with reference to accompanying drawings and embodiments.

### BRIEF DESCRIPTION OF THE DRAWINGS

FIG. 1 is a flow chart illustrating an Ethernet data transmission method in accordance with Embodiment one of the present invention.

FIG. 2 is a schematic diagram illustrating internal structure of a PHY transmission apparatus in accordance with Embodiment two of the present invention.

### DETAILED DESCRIPTION OF THE INVENTION

### Embodiment One

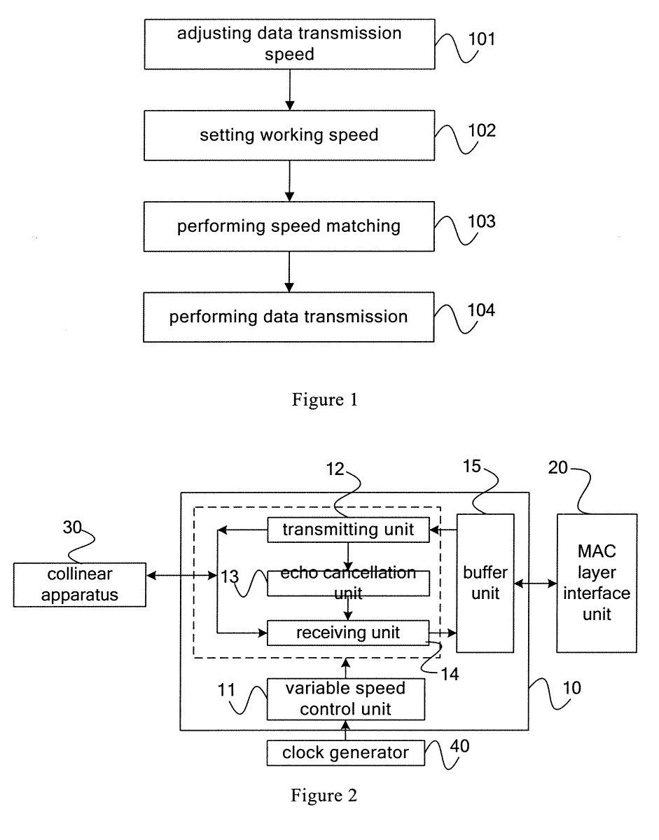

This embodiment provides a TV network based Ethernet data transmission method. As shown in FIG. 1, the method includes the following blocks.

Block 101: data transmission speed is determined in advance according to bidirectional frequency spectrum width reserved in a TV network. Specifically, processes for determining the data transmission speed may be different according to differences of coding modes adopted by the Ethernet. For instance, if the Manchester coding mode of the 10M Ethernet is adopted, the value of occupied bandwidth is twice as that of the data transmission speed. It is necessary to adjust value of the transmission speed to a half of that of the bidirectional frequency spectrum width reserved in the TV network. Specifically, if the bidirectional frequency spectrum width reserved in the TV network is 65 MHz, the adjusted data transmission speed is 65/2=32.5 Mbps. If the 4B/5B coding mode of the 100M Ethernet is adopted, value of the occupied bidirectional frequency spectrum width is five-fourths of the value of data transmission speed, and it is necessary to adjust value of the transmission speed to four-fifths of value of the bidirectional frequency spectrum width reserved in the TV network. For instance, if the bidirectional frequency spectrum width reserved in the TV network is 65 MHz, adjusted data transmission speed is 65*4/5=52 Mbps. It should be noted that, the data transmission speed may be determined only based on a portion of the bidirectional frequency spectrum width reserved in the TV network. For instance, the data transmission speed may be determined only utilizing 60 MHz of the 65 MHz frequency spectrum width according to the same method mentioned above.

Block 102: working speed of a PHY transmission apparatus is set according to the adjusted data transmission speed, such that the working speed and the data transmission speed may be matched. Specifically, the working speed of the PHY transmission apparatus may be set by adjusting an internal reference clock or an external clock generator of the PHY transmission apparatus. The former is applicable to a scene in which the working speed changes with integer multiple, and the change may be implemented with frequency multiplication or frequency division, for instance, a change from 10 Mbps to 20 Mbps, etc. The latter is applicable to a scene in which the working speed changes with non-integer multiple, and the change can not be conveniently implemented with frequency multiplication or frequency division, for instance, a change from 100 Mbps to 52 Mbps, etc. In such a case, the needed working speed may be directly generated by the external clock generator. The PHY transmission apparatus refers to a transmission unit that may implement the PHY function, for instance, a Physical Layer (PHY for short) chip. According to existing Ethernet transmission standard, data may firstly be sent to the PHY via a TV network transmission line, and be sent to Media Access Control (MAC) layer for processing, and then be sent to an upper layer for further processing.

Block 103: when it is necessary to transmit data, performing speed matching for received data. Specifically, when it is necessary to receive data from the TV network, receiving data with the above-mentioned transmission speed from the TV network transmission line, and performing speed matching for the received data according to speed of an MAC layer interface. When it is necessary to transmit data to the TV network, after receiving data from the MAC layer, the MAC layer interface performs speed matching for the data according to the working speed of the PHY transmission apparatus. The receiving and transmitting processes may be performed synchronously or in sequence. Generally, the transmitting and receiving processes may be synchronously performed for Ethernet data transmission. The TV network transmission line refers to a transmission line accessing user terminals by the TV network.

In block 102, since the working speed of the PHY transmission apparatus changes, the working speed of the PHY and that of the MAC layer may be not matched. Thus, it is necessary to perform the speed matching. There may be a lot of specific matching methods. For instance, if an MAC layer interface with a standard speed is adopted, i.e., speed of the MAC layer interface can not be changed, and then received data may be buffered. Specifically, a First In First Out (FIFO) buffer may be adopted to buffer the received data, such that the speed matching may be implemented. Alternatively, if an MAC interface with a non-standard speed is adopted, i.e., speed of the MAC layer interface may be changed, the speed matching may be implemented by adjusting the interface speed of the MAC layer interface with the non-standard speed.

Block 104: the TV network transmission line and the MAC layer are adopted to perform data transmission after the speed matching is implemented. Specifically, when it is necessary to receive data from the TV network, data is transmitted from the TV network transmission line to the MAC layer interface, and then the data is transmitted to upper layer for further processing. When it is necessary to transmit data to the TV network, data is transmitted by the MAC layer through the MAC layer interface to the TV network transmission line, and then the data is transmitted to the TV network.

With the method described in this embodiment, the Ethernet may be transmitted via the TV network, the bidirectional frequency spectrum width reserved in the TV network may be fully utilized, and transmission speed of the Ethernet may be enhanced as much as possible.

### Embodiment Two

An embodiment of the present invention provides a PHY transmission apparatus capable of supporting variable speed Ethernet transmission over the TV network. As illustrated in FIG. 2, the PHY transmission apparatus 10 includes a transmitting unit 12, a receiving unit 14, a variable speed control unit 11, a buffer unit 15 and an echo cancellation unit 13. The PHY transmission apparatus 10 respectively connects to a collinear apparatus 30 and an MAC interface unit 20. The buffer unit 15 may be implemented with a FIFO buffer. The variable speed control unit 11 may be implemented with a reference clock setting module. Working process of the apparatus described in this embodiment is as follows.

Data transmission speed is determined in advance according to bidirectional frequency spectrum width reserved in a TV network. Specifically, processes for adjusting the transmission speed may be different according to differences of coding modes adopted by the Ethernet. For instance, if the Manchester coding mode of the 10M Ethernet is adopted, value of occupied bandwidth is twice as that of the data transmission speed. It is necessary to adjust value of the transmission speed to a half of the value of the bidirectional frequency spectrum width reserved in the TV network. Specifically, if the bidirectional frequency spectrum width reserved in the TV network is 65 MHz, adjusted data transmission speed is 65/2=32.5 Mbps. If the 4B/5B coding mode of the 100M Ethernet is adopted, value of the occupied bandwidth is five-fourths of that of the data transmission speed. Thus it is necessary to adjust value of the transmission speed to four-fifths of the value of the bidirectional frequency spectrum width reserved in the TV network. Specifically, if the bidirectional frequency spectrum width reserved in the TV network is 65 MHz, adjusted data transmission speed is 65*4/5=52 Mbps.

A reference clock setting module of the variable speed control unit 11 is adjusted according to the adjusted data transmission data, and then working speed of the transmitting unit 12 and working speed of the receiving unit 14 in the PHY transmission apparatus 10 are configured, such that the above two configured working speeds may be matched with the data transmission speed. Alternatively, a clock generator 40 may be set outside of the PHY transmission apparatus 10. The reference clock setting module may be set via the clock generator 40, and then the working speed of the transmitting unit 12 and the working speed of the receiving unit 14 may be set.

Data with the above-mentioned transmission speed which comes from the TV network transmission line may be transmitted to the PHY transmission apparatus 10 via the collinear apparatus 30. After receiving the data, the receiving unit 14 of the PHY transmission apparatus 10 processes the data and transmits the data to the buffer unit 15. The receiving unit 14 may include the following functions units, such as a received signal detecting unit, a receiving automatic amplifying unit, a receiving analog-digital conversion unit, an inter-symbol interference cancellation unit, a transmission decoding unit and a receiving decoding unit according to transmission requirements of the Ethernet, so as to perform corresponding processes for the received data.

After receiving the data from the receiving unit 14, the buffer unit 15 buffers the received data so as to implement the speed matching with the MAC layer interface unit 20. In the previous block, since the working speed of the PHY transmission apparatus changes, the working speed of the PHY and that of the MAC layer may be not matched. Thus, it may be necessary to perform speed matching. In addition, it should be noted that the MAC layer interface unit 20 in the block adopts an MAC layer interface with a standard speed, i.e., speed of the MAC layer interface can not be changed. Thus, it is necessary to perform buffer adjustment for data speed by using the buffer unit 15, so as to perform the speed matching. In addition, if the MAC layer interface unit 20 adopts an MAC layer interface with a non-standard speed, i.e., speed of the MAC layer interface may be changed, the speed matching may be implemented by correspondingly configuring the speed of the MAC layer interface with the non-standard speed. Therefore, in such a case, the buffer unit 15 may not be configured in the PHY transmission apparatus 10, to reduce number of components in the PHY transmission apparatus and to reduce costs.

After completing the speed matching, the buffer unit 15 transmits the data to the MAC layer interface unit 20, so that the data may be transmitted to the MAC layer for further processing and a process for receiving data may be completed.

Correspondingly, when it is necessary to transmit data, the MAC layer interface unit 20 transmits data coming from the MAC layer to the buffer unit 15. The buffer unit 15 buffers the data received from the MAC layer interface unit 20 to implement the speed matching, and then transmits the matched data to the transmitting unit 12. If the MAC layer interface unit 20 adopts an MAC layer interface with a non-standard speed, i.e., speed of the MAC layer interface may be changed, the speed matching may be implemented by performing corresponding configuration for the speed of the MAC layer interface with the non-standard speed. Thus, in such a case, the buffer unit 15 may not be configured in the PHY transmission apparatus 10, and the MAC layer interface unit 20 may directly transmit the data received from the MAC layer to the transmitting unit 12 of the PHY transmission apparatus 10.

The transmitting unit 12 may include the following function units, such as a transmitting coding unit, a transmitting digital-analog conversion unit and a transmitting amplifying unit according to transmission requirements of the Ethernet, so as to perform corresponding processes for data to be transmitted. After completing the processes, the data is transmitted to the TV network transmission line, for instance a coaxial-cable, via the collinear apparatus 30 to implement the data transmission.

In addition, since data transmission and data reception are synchronously implemented by the PHY transmission apparatus 10, in order to effectively restore the received data, the echo cancellation unit 13 may be set between the transmitting unit 12 and the receiving unit 14 to cancel the echo generated by proximal transmission when performing the data transmission. Specifically, the echo cancellation unit 13 may connect with the transmitting digital-analog conversion unit in the transmitting unit 12.

With the PHY transmission apparatus provided by the embodiment of the present invention, the Ethernet transmission via the TV network may be implemented, the bidirectional frequency spectrum width reserved in the TV network may be fully utilized, and speed for transmitting Ethernet may be enhanced as much as possible.

It should be noted that the foregoing are only preferred embodiments of the present invention and are not intended to limit the protection scope of the present invention. Although detailed descriptions have been provided for the application with reference to preferred embodiments, persons having ordinary skill in the art may learn that any modification, equivalent substitution made without departing from the spirit and principle of the present invention should be covered by the protection scope of the present invention.

1. A television, TV, network based Ethernet data transmission method, comprising:
receiving and transmitting, by a Physical Layer, PHY, transmission apparatus, Ethernet data with a predetermined transmission speed, wherein the transmission speed is determined according to bidirectional frequency spectrum width reserved in a TV network;
performing speed matching for the Ethernet data according to speed of a Media Access Control, MAC, layer interface.

2. The TV network based Ethernet data transmission method according to claim 1, further comprising:
setting working speed of the PHY transmission apparatus by adjusting a reference clock or an external clock generator of the PHY transmission apparatus.

3. The TV network based Ethernet data transmission method according to claim 1, wherein
the transmission speed is determined according to the bidirectional frequency spectrum width reserved in the TV network and a preselected coding mode.

4. The RTV network based Ethernet data transmission method according to claim 3, wherein the preselected coding mode comprises:
a Manchester coding mode or a 4B/5B coding mode.

5. The TV network based Ethernet data transmission method according to claim 1, wherein performing the speed matching for the Ethernet data according to the speed of the MAC layer interface comprises:
buffering the data or adjusting interface speed of an MAC layer interface with non-standard speed to make the speed of the data from the PHY transmission apparatus match the data speed of the MAC layer.

6. A Physical Layer, PHY, transmission apparatus for transmitting Ethernet data over a television, TV, network, adapted to connect to an external collinear apparatus and a Media Access Control, MAC, layer interface unit at two ends of the PHY transmission apparatus, wherein the PHY transmission apparatus comprises:
a transmitting unit,
a receiving unit and
a buffer unit, which is connected to the MAC layer interface unit, the transmitting unit and the receiving unit, and the buffer unit is adapted to perform speed matching for data transmitted between a TV network transmission line and an MAC layer.

7. The PHY transmission apparatus according to claim 12, wherein the variable speed control unit comprises:
a reference clock setting module, adapted to set the working speed of the PHY transmission apparatus.

8. The PHY transmission apparatus according to claim 7, further comprising:
a clock generator set outside of the PHY transmission apparatus, which is connected to the reference clock setting module, adapted to configure the working speed by setting the reference clock setting module.

9. (canceled)

10. The PHY transmission apparatus according to claims 6, further comprising:
an MAC layer interface with a non-standard speed set outside of the PHY layer transmission apparatus, connected to the transmitting unit and the receiving unit, and adapted to perform speed matching for data transmitted between a TV network transmission line and an MAC layer.

11. The TV network based Ethernet data transmission method according to claim 1, wherein the transmission speed is non-standard speed.

12. The PHY transmission apparatus according to claim 6, further comprising:
a variable speed control unit, adapted to set working speed of the transmitting unit and that of the receiving unit according to data transmission speed which is determined based on bidirectional frequency spectrum width reserved in the TV network.

13. The PHY transmission apparatus according to claim 7, further comprising:
an MAC layer interface with a non-standard speed set outside of the PHY layer transmission apparatus, connected to the transmitting unit and the receiving unit, and adapted to perform speed matching for data transmitted between a TV network transmission line and an MAC layer.

14. The PHY transmission apparatus according to claim 8, further comprising:
an MAC layer interface with a non-standard speed set outside of the PHY layer transmission apparatus, connected to the transmitting unit and the receiving unit, and adapted to perform speed matching for data transmitted between a TV network transmission line and an MAC layer.

15. The PHY transmission apparatus according to claim 12, further comprising:
an MAC layer interface with a non-standard speed set outside of the PHY layer transmission apparatus, connected to the transmitting unit and the receiving unit, and adapted to perform speed matching for data transmitted between a TV network transmission line and an MAC layer.

16. A system for transmitting Ethernet data over a television, TV, network, comprising a Physical Layer, PHY, transmission apparatus and a Media Access Control, MAC, layer interface with a non-standard speed set outside of the PHY layer transmission apparatus, wherein
the PHY transmission apparatus, which comprises a transmitting unit and a receiving unit, is adapted to connect to an external collinear apparatus and an MAC layer interface unit at two ends of the PHY transmission apparatus;
the MAC layer interface, which is connected to the transmitting unit and the receiving unit, is adapted to perform speed matching for data transmitted between a TV network transmission line and an MAC layer.
